(19) United States
(12) Patent Application Publication
(10) Pub. No.: US 2016/0165221 A1
(43) Pub. Date: Jun. 9, 2016

(54) Simulated 3D Projection Apparatus

(71) Applicant: John Paul Duffy, Toronto (CA)

(72) Inventor: John Paul Duffy, Toronto (CA)

(21) Appl. No.: 14/560,275

(22) Filed: Dec. 4, 2014

(51) Int. Cl. H04N 13/04; G09G 3/36

(52) U.S. Cl. CPC H04N 13/0411; H04N 13/0495; H04N 13/0459; H04N 13/0497; G09G 3/36; G09G 2300/023

(57) ABSTRACT

A display apparatus for displaying simulated 3D images is provided which is preferably portable and scalable in size, and comprises a front display device having side edges, arranged to project a first image of a first program material towards a viewer, and a background display device having side edges, arranged to project a second image of a second program material towards a viewer, wherein said front display device and said background display device are separated to provide an apparent parallax effect between said first image and said second image, and wherein said background display device extends beyond the side edges of the front projection device. The display device provides a parallax effect which can extend to the edges of the front display device.

### FIELD OF THE INVENTION

This invention relates to projection apparatus, and in particular the invention relates to a projection apparatus which is portable and scalable, and which is used in a manner so that a viewer will see a video presentation which comprises a simulated three dimensional (3D) image comprising a virtual image which is seen against a background wherein the background may contain a further image which varies in a programmed manner in keeping with the actions being portrayed by the virtual image. Preferably, the present invention relates to apparatus and devices which may be employed in theatrical, educational, or medical presentations, for example, and more particularly in advertising or other presentations which are intended to promote and/or extol the features and advantages of any product or service being offered for sale.

### BACKGROUND OF THE INVENTION

The present invention finds its genesis in an theatrical illusion which is widely known as “Pepper's ghost”. In this illusion, a viewer is made to believe that he is seeing an article which does not, in fact, exist in the setting or circumstances being viewed. The techniques involved in presenting Pepper's ghost are described hereafter. However, for now, a brief description and history of Pepper's ghost is provided.

In order for the classical Pepper's ghost illusion to work properly, the viewer must see clearly into a main setting, but not see into a hidden room. Unknown to the viewer, the viewer is also viewing the main setting through an angled piece of glass which, because of its placement, can be both translucent and reflective. By changing the lighting in the hidden room, the viewer can view a reflection of the lit contents of the hidden room, on the glass panel. Thus, the illusion is controlled by its illumination, and will appear and disappear when the lighting of the object, person, or the like, is turned on or off, respectively. As a result, an object or person which is reflected in the “mirror” section of the glass (e.g. the reflective surface of the glass) may seem to appear or disappear, or change into another object. While this illusion is over 100 years old, the same effect has been employed since at least the 1960's in certain modern theme parks, where objects such as reflected animated props can create the appearance of translucent “ghosts” which appear to be moving through a particular setting and interacting with props in that physical particular setting. Moreover, the images appear to be three dimensional and demonstrate a parallax effect with respect to other items on the stage.

Typically, in recent applications, a polymeric film, drawn tight within a metal frame, is used to replace the glass panel, and a projection device is used to create the image to be displayed on the polymeric film. Construction of the film and associated frame, and the projectors to be used, are well known in the art, and outside of the scope of the present invention.

As an example, U.S. Pat. No. 8,172,400 (O'Connell et al.) describes a projection apparatus which requires a first projection device that is arranged to generate a virtual three dimensional object by projection of the image onto to a reflected/translucent polymer film. A second projection device projects a background image; and a light source projects light onto the virtual three dimensional image. A stage arrangement can also be provided, which is placed behind the screen, upon which a presenter or actor, or a prop, or both, may be located, in order that the presenter or prop, interact with the virtual image.

In more recent applications, such as those described in US Patent publication No. US 2013/0300728 (“Reichow et al.), the polymeric film or glass panel showing the reflection is replaced by a transparent front display device, such as an transparent LCD display device. In this approach, the reflective surface with its projected image, is no longer required since the virtual image can be displayed directly on the transparent front display. A second background display device is positioned visually behind the transparent front display, and a background image is shown or projected directly on the background display device. The images shown on the background display device can be coordinated with the images on the transparent front display in order to create an apparent parallax effect which provides images which are similar to images from the Pepper's Ghost technique.

Additional display panels can be provided between the front display and the background display, in order to provide additional image content. However, for simplicity, the use of a two panel approach will be discussed in the present document.

Current uses of this simulated 3D presentation technique include, for example, the display of advertising materials in a simulated 3D environment, or the simultaneous presentation of a speech to numerous groups in many different locations, using a virtual image. Other applications have included providing a virtual performance by a performer, even though, in some cases, the performer is no longer alive.

However, unless a visual “ghost” effect is desired, it has typically been necessary to employ a black background surface behind the virtual image so as to avoid any background image showing through the virtual image. This is because if the viewer were to see the background image through the front image, it would destroy the “holographic” effect of the virtual image.

More recently however, the background image is adjusted so as to be coordinated with the transparent front image so that the two images are mated one to the other. As an example, a blacked-off “masked” area can be provided on the background display which masked image moves and/or is otherwise coordinated with the image on transparent front display so as to minimize or eliminate the background image from bleeding through the image on the front display.

In order to provide a simulated 3D effect using a front panel and a background panel (or any additional intermediate display panels), it is necessary to provide at least some distance between the transparent front display and the background display. This distance typically varies depending on the size of the display, and is used to create the parallax effect.

In a common approach, the front display is roughly the same size as the background display, and the two display devices are positioned so as to be essentially parallel and co-planar, one to the other. When viewed from a side angle, however, this allows the viewer to see the front panel, but also view beyond the edges of the back panel. In some situations, this “panel separation” effect can be minimized by providing a “blacked-out” area between the display devices. However, when the background panel images are coordinated to the images on the front display, the effect of the edge of the back panel, become more evident, since the images on the background device simply end at the edge of the background display device.

As such, it would be beneficial to provide a simulated 3D display device of the type described herein, wherein this panel separation effect at the edge of the background panel, is reduced or eliminated.

The present inventors have unexpectedly discovered that the panel separation effect can be minimized in a fashion such that an improved, coordinated simulated three dimensional illusion which may be viewed simultaneously by a plurality of viewers.

To achieve this effect, the inventors herein provide an apparatus which has the ability to deliver real depth perception having two (or more) display panels, so as to create advanced visualizations which may employ animated and/or virtual holographic content using apparent parallax, while reducing or eliminating the panel separation effect.

### SUMMARY OF THE INVENTION

In a first aspect, the present invention therefore provides a simulated 3D display apparatus comprising a front display device having side edges, arranged to project a first image of a first program material towards a viewer, and a background display device having side edges, arranged to project a second image of a second program material towards a viewer, wherein said front display device and said background display device are separated to provide an apparent parallax effect between said first image and said second image, and wherein said background display device is sized so as to extend beyond the side edges of the front projection device.

In a further embodiment, the background display device is curved or angled so as to extend towards the plane of the front projection device. In a most preferred embodiment, the edges of the background display device extend essentially to the plane of the front display device.

The front display device can be any suitable display device which can include a prior art reflective film or glass onto which an image is projected. More preferably however, the front display device is a transparent display device, and most preferably, the front display device is a flat panel, transparent LCD display device. The flat panel of the front display device creates a plane which extends beyond the edges of the front display panel, and thus provides an extended plane of the front display panel.

The background display device can also be any suitable display device, which can include a screen onto which an image can be projected (either from the front or rear). Most preferably, the background display device is a display device such as a television screen or monitor. These can include any suitable display devices, but preferably, flat panel display devices such as LCD, plasma, LED, OLED, and the like, are used.

The background display device can also be provided by a plurality of display devices, wherein each of the display devices is preferably a television or a monitor. This can include televisions or monitors that are rear projection devices, but more preferably, the rear screen is chosen from the group consisting of a planar television tube, a planar plasma television display, a planar LCD television display, a planar LED television display, and a planar OLED television display. Other display devices might also be used as the rear screen, and the skilled artisan will be aware that their use is not precluded from the present invention.

Where a plurality of display devices are used, the background display can comprise a plurality of devices which are arranged to provide a completed background display. For example, 4 devices can be arranged in a planar 2×2 grid. Other arrangements are possible, and these can include 3×3 grids, 4×4 grids, 2×3 grids, 3×2 grids, or any other suitable arrangement.

Other types of projector devices can also be utilized, as well as combination of different display devices.

In a first embodiment, the background panel is parallel to, and co-planar with the front display panel, but extends beyond the sides of the front panel display. Preferably, the background panel extends at least 5% beyond the edge of the front display device (based on the width of the front display device). More preferably, the background display device extends at least 10%, and more preferably, at least 20% beyond the side edges of the front display device.

Preferably, the background display device extends beyond the front display device on at least two sides, but extending the background display beyond the edges of the front display device, on all four sides is not excluded from the present invention. As such, in one embodiment, the front display device is a given size of display panel, and the background display panel is selected so as to larger than the front display panel, and thus extend beyond the edges of the front display panel.

With this approach, a viewer who views the image on the front display panel on an angle, will still view an image on the outer edges of the background panel.

In a more preferred embodiment, the background panel is curved or angled such that the outer edges of the background panel extend towards the extended plane of the front display panel.

The background display can be a curved panel display device, wherein at least the edges of the display device can be curved towards the extended plane of the front display panel. Most preferably, the background display is provided as a flexible display device which is placed so as to provide a continuously curved display panel behind said front display device.

The background display can also be comprised of a plurality of panels configured to provide a suitable display. As examples, the background display could be a flat panel display device which is parallel to the front panel, and also having additional background display panels at its edges which are angled towards the extended plane.

The background display device might also be two flat panel display devices, both angled with respect to the front display panel, wherein the outer edges of the background display devices extend towards the extended plane.

The background display devices have at least a portion that extends towards the extended plane of the front display device. As a result, the edges of the background display device extends towards the extended plane of the front display by a distance which is at least 25% of the maximum distance between the front and background display devices. More preferably, the background device display devices extend to at least 50%, and more preferably, at least 75% of the maximum distance of between the front and background display devices.

In some embodiments, the edges of the background display devices can extend so as to essentially intersect the extended plane of the front display panel, and thus, the background display devices extend 100% of the maximum distance between the front and background display devices.

The front and background display device are preferably vertically orientated with respect to the viewer, although this is not required. Moreover, the background display device is preferably vertically aligned, in at least one direction, with respect to the front display device. Thus, in one direction (e.g. up and down), the background display device is a constant distance from the front display panel, even though in another direction (left and right) the distance between the front and background display devices, is changing.

The background display device can also extend beyond, and be curved, towards the front display device, on all four sides. This could be accomplished by, for example, having a background display device with a central panel, which is surrounded by four display devices angled towards the extended plane of the front display device.

The size of the front and background panels can vary, as can the distance between them depending on their size.

Additional transparent display devices can be positioned between the front and background display devices. The edges of these additional devices can also extend beyond the edges of the front display device, but this is not required. Commonly the number of additional transparent display devices will be between 1 and 10, and most preferably, the number of additional transparent display devices will be between 1 and 3.

In a preferred embodiment, the first program material and the second program material are edited and synchronized one with the other so that the images from the background display device appear to be interrelated to, or merge into, the program material on the front display device, and thus provide a simulated 3D viewing experience.

It will be noted that the images of the first program material and the images of the second program material can be independent. However, in keeping with the present invention, preferably the images of the first program material and the images of the second program material are synchronized. Typically, synchronization of the first program material and the second material is preferably under the control of a computer, or some other computerized device. Synchronization of the images moving from display device to display device, can be provided by this arrangement.

The apparatus of the present invention is preferably arranged so that images from the first program material and/or the second program material are altered or edited, in such a manner so that any chosen image from first program material displayed on the front display device, will create an image which will appear to be aligned with an area of the second program material presented on the background display device. In a preferred arrangement, the first program material will appear to be superimposed, or in front of, the edited second program material on the rear screen. In one particularly preferred arrangement, the second program material is altered so that no image is provided in the area behind the image provided in the first program material. As such, the first program material image is provided without any image from the second program material being superimposed on, or under, the first program image.

Still further, the editing and placement of the first program material image and the edited area of the second program material image are such that the chosen image of the first program material and the edited area of the second program material may be made to move in any direction, relative one to the other, from frame to frame of the virtual image and the second program material image. As such, the directions of movement from frame to frame of the virtual image, and the edited area of the second program material image can be in opposite directions, so as to provide an enhanced illusion of movement one with respect to the other.

Editing and placement of the second program material on the background display device might also be required to address the non-linear nature of the background display device, and/or the non-parallel or non-planar positioning of the second display device.

Other options to control the interrelated appearance of the combined visual images can be further controlled, and synchronized. For example, there is typically a transparency value which is associated with any color. In a projection based system, the color black is 100% transparent, in terms of the image projected from the display device. The color white is essentially opaque, with the other colors being in between. In contrast, however, for a transparent LCD monitor, a 100% white level is transparent, revealing the background display, and a 100% black level would be essentially opaque, which would conceal the background image.

In either approach however, transparency of colors can result in problematic imagery when multiple planes of visualization are employed. For example, imagery in the background display device will be revealed in any transparent area in the front display device with the result that the image gives the impression of being “ghostly”.

However, these shortcomings can be overcome or ameliorated by controlling the opacity and luminance levels of the front display device, and/or by using techniques such as providing “traveling mattes” on the rear screen. To be more specific, adjusting the opacity and luminance values of the background display or the front display, with respect to each other, can improve the perceived image parallax and the foreground image fidelity, of the system. In that regard, it is typically preferred, but not essential, that the background opacity should be adjusted to between 20% and 40% of the foreground layer so as to achieve a well perceived three dimensional effect.

The use of traveling mattes may be achieved physically, but in most cases, is done by editing the image content using a computer application. Essentially, a traveling matte is an artificial black mask that is a “cut-out” of the foreground imagery, and which is applied to the corresponding background plane. This results in a significant improvement to the overall effect. Obviously, the masks which are applied to the background imagery are synchronized to, and in traveling time with, the foreground imagery, and are sized so as to approximate the size of the foreground image. Typically, the matte is between 80 and 120% of the size of the foreground image.

Overall, the creation of various content aspects in accordance with the present invention, including, for example, parallax, relative opacity, luminance, travelling mattes, and the like, acts to provide an improved and enhanced simulated 3D experience. In the present invention, this content creation is achieved through editing, synchronizing and/or interrelating the virtual image (or images) to the background image.

Moreover, the present invention provides a display apparatus for displaying simulated 3D images, which is preferably both scalable and portable. For example, in a particular embodiment of the present invention, the front and background display devices are permanently mounted in a case so as to be portable as a single structure, as will be hereinafter described. For this embodiment, the case will preferably be limited to a box having a length, height and width, of less than about 2.25 m, and more typically, less than 1.5 m. For smaller devices, the box can have length, height and width values which are all less than 40 cm.

In another option, a hand-held device can be provided wherein the box will typically have length, height and width values which are all greater than 5 cm, and more preferably, greater than 10 cm.

Larger cases of up to, for example, 3 to 5 metres, are also possible, and are not excluded from this invention. These larger cases may be provided as cases which can be moved from one exhibition site to another as a single structure.

However, the general techniques for providing the simulated 3D visualizations, in keeping with the present invention, will also apply to structures which employ the same principle hardware and software, but which may be more or less permanently installed in such locations or devices such as a theatre, an outdoor display, or television studio. Scalability therefore allows the system to be used in a wide variety of situations, and as such, one feature of a certain aspect of the present invention is that the apparatus is scalable. That is, the apparatus may vary in size from perhaps that of a computer, to the size of a small trailer. For even larger applications, the apparatus of the present invention can be configured so as to be used on a stage such as might be found in a theatre, conference center, or the like.

### BRIEF DESCRIPTION OF THE DRAWINGS

The novel features which are believed to be characteristic of the present invention, as to its structure, organization, use and method of operation, together with further objectives and advantages thereof, will be better understood from the following drawings in which a presently preferred embodiment of the invention will now be illustrated by way of example. It is expressly understood, however, that the drawings are for the purpose of illustration and description only and are not intended as a definition of the limits of the invention. Embodiments of this invention will now be described by way of example in association with the accompanying drawings in which:

FIG. 1 is a sketch showing the general layout and functioning principles of a prior art Pepper's Ghost installation;

FIG. 2 is a perspective view of a prior art system with a transparent front display;

FIGS. 3 is an overhead schematic view of the prior art system of FIG. 2;

FIG. 4 is perspective view of a first embodiment of a transparent front display system of the present invention;

FIG. 5 is an overhead schematic view of the system of FIG. 4;

FIG. 6 is perspective view of a second embodiment of a transparent front display system of the present invention;

FIG. 7 is an overhead schematic view of the system of FIG. 6;

FIG. 8 is perspective view of a third embodiment of a transparent front display system of the present invention;

FIG. 9 is an overhead schematic view of the system of FIG. 8;

FIG. 10 is an overhead schematic view of a further embodiment of the transparent front display system of the present invention; and

FIG. 11 is perspective view of a still further embodiment of a transparent front display system of the present invention.

### DETAILED DESCRIPTION OF THE PREFERRED EMBODIMENTS:

The novel features which are believed to be characteristic of the present invention, as to its structure, organization, use and method of operation, together with further objectives and advantages thereof, will be better understood from the following discussion.

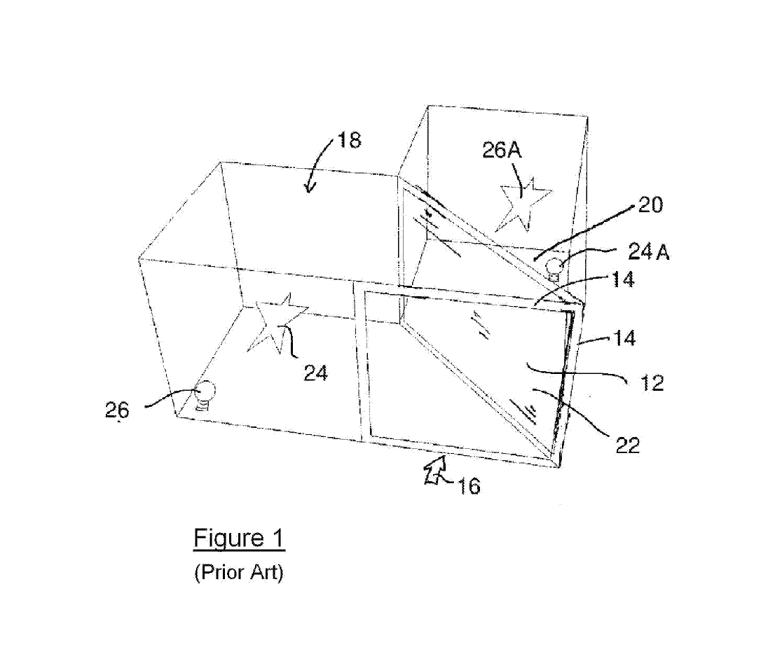

FIG. 1 is a sketch showing a classic arrangement by which the Pepper's ghost illusion was exhibited starting in the last half of the 19th century. A stage, typically a proscenium stage, is shown at 12 in FIG. 1, and has a proscenium 14. It will be seen that the left hand side of the stage is open; that is, there is no wall, wing drapery, or the like. However, a viewer looking at the stage 12 in the direction of arrow 16 sees nothing of the apparatus and setup at the left-hand side of the stage 18. Moreover, all of the structure at the left-hand side of the stage, commonly referred to as a Blue Room 18 (although it is usually black), is kept dark. That is, there is no illumination in the blue room 18, and the stage 20 is typically brightly lit. A glass panel 22 is set at an angle to the viewing direction 16. Whatever is behind the glass 22 is clearly seen by the viewer.

Under normal lightly conditions, there is no reflection seen on the front face of the glass 22 from the setting in the blue room 18.

Objects 24 and 26 are placed in the blue room 18. When illumination is turned on in blue room 18, a reflection of what is in the blue room 18 is seen in the glass 22, but appears to provide a virtual image 24A and 26A, which can be seen by the viewer. When the lighting in the blue room 18 is discontinued, the images 24A and 26A, appear to disappear.

The present system is a variation of the Pepper's Ghost illusion wherein a front image is provided on a transparent front display, and can be made to be interrelated to images appearing on a background display unit. This creates parallax in the system, which provides a simulated 3D effect.

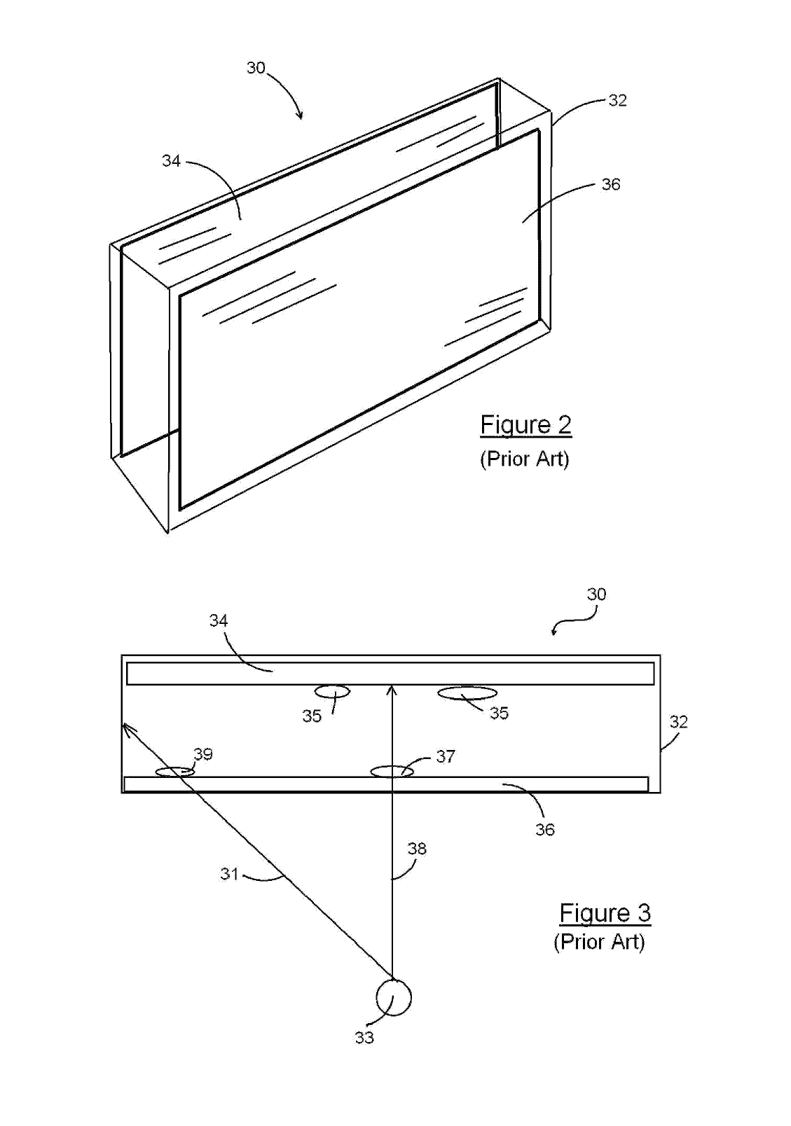

Turning now to FIGS. 2 and 3, an illustration of a prior art display system apparatus 30 is shown. Apparatus 30 consists of a case 32, in which a background display screen (namely a flat panel LCD television) 34 is shown at the back of case 30. At the front of case 30 is a front transparent LCD display 36.

Case 32 can have any suitable width, height or depth, as required for the environment where apparatus 30 is used. By way of example, for a display item, case 32 could have a width of 2 meters, a height of 1.5 meters, and a depth of 1 meter. Obviously, the height, width and depth relationships can be modified as required or as needed.

As best seen in FIG. 3, when viewed in the direction shown by arrow 38, a viewer 33 will see the image, which is represented by reference numeral 37, shown on front display 36, against an image represented by reference numerals 35 on the background display 34, when the viewer 33 views the images from directly in front of case 32.

As such, the two program material images are interrelated. The programming and the nature of the computers employed to interrelate the images, and their synchronization, are beyond the scope of the present invention. Similarly, the brightness and luminosity of the images on the front display 36 and/or background display 34 can also be controlled, and thus, are also edited or synchronized so as to be interrelated, one to the other.

When viewing the image represented by reference numeral 39, however; -which is near the edge of front display 36, as shown by the arrow 31, the viewer 33 will see the sides of case 32 and/or will lose any effect that might be desired on a background display located visually behind image 39.

The present invention seeks to address this situation.

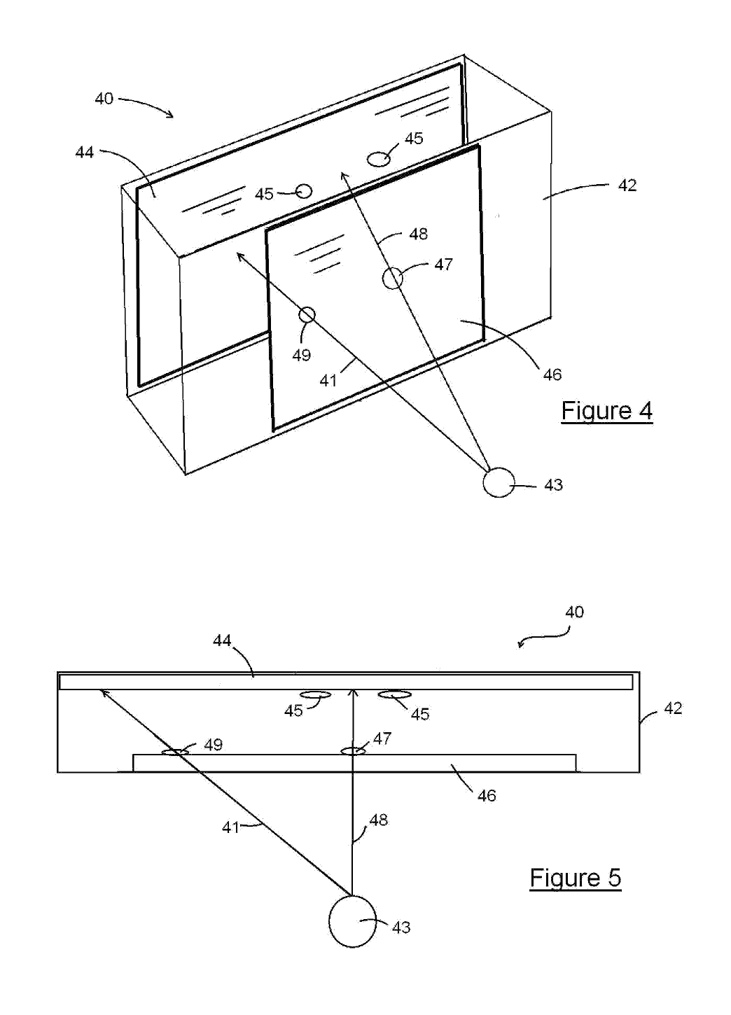

In FIGS. 4 and 5, an illustration of the display system apparatus 40 according to the present invention is shown. In this approach, apparatus 40 comprises a case 42, in which a background display screen 44, is shown near the back of case 42. As in FIGS. 2 and 3, at the front of case 40 is a front transparent LCD display 46. In this embodiment, background screen 44 is 30% larger, when measured side-to-side, than transparent front display 46. When viewed in the direction shown by arrow 48, the viewer 43 will see the image 47 shown on front display 46, against the backdrop of the image 45 shown on background display 44, when the viewer 43 views the images from directly in front of case 42.

When viewing image 49 near the edge of front display 46, as shown by arrow 41, the viewer 43 still sees the image 49 against the backdrop of background display 44. As such, the viewer does not lose the effect of having the background display behind image 49.

It will be noted that in this embodiment, background display 44 and front display 46 have essentially the same height, and only their width is different. For most applications, this approach is acceptable, however, clearly, background display 44 can be modified so as to have a larger height than front display 46.

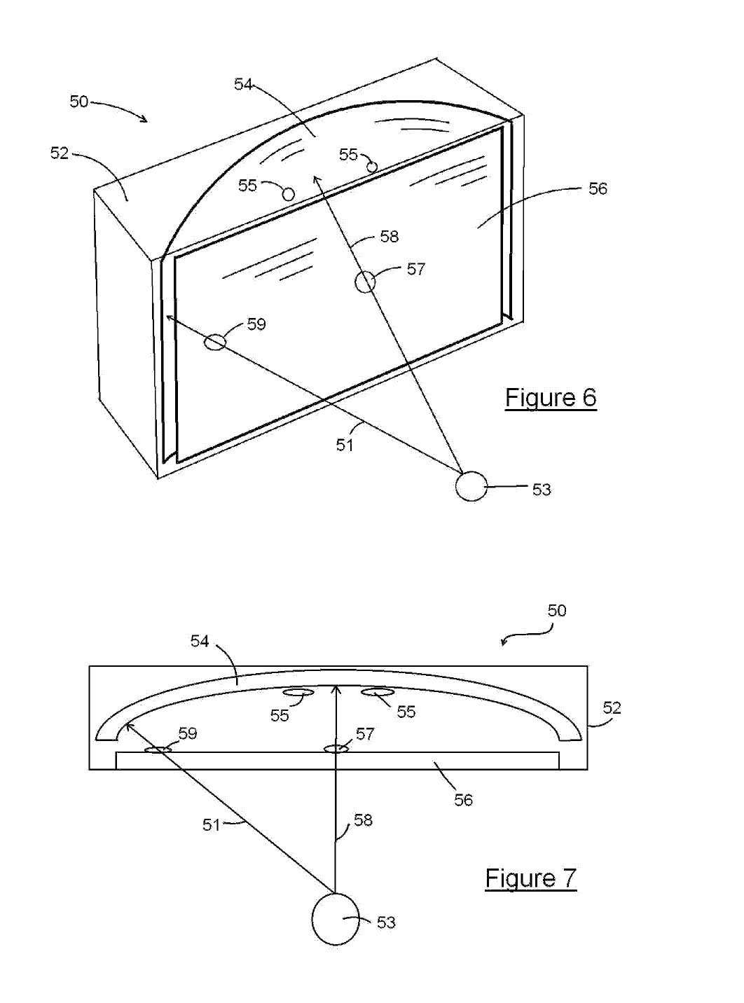

In FIGS. 6 and 7, a further embodiment of the display system apparatus 50 of the present invention is illustrated. In this approach, apparatus 50 comprises a case 52, in which a background screen 54, which is a flexible LCD screen, having a continuously curving arrangement, is shown near the back of case 50. As in FIGS. 2 and 3, at the front of case 50 is a front transparent LCD display 56. When viewed in the direction shown by arrow 58, the viewer 53 will see the image 57 shown on front display 56, against the backdrop of the image 55 shown on background display 54, when the viewer 53 views the images from directly in front of case 52.

When viewing image 59 near the edge of front display 56, as shown by arrow 51, the viewer 53 still sees the image 59 against the backdrop of background display 54. As such, the viewer does not lose the effect of having the background display behind image 59.

Again, front display 56 and background display 54 are shown having a the same height. Since background display 54 curves behind, and past, front display 56, it is clear that background display 54 is wider than front display 56. This arrangement can be varied, as necessary.

It will also be noted that while background display 54 is has a constant distance, along a vertical axis on front display 56, the distance from the background display 56 to the front display changes as one moves in a horizontal direction across the front display 56. While this is a preferred arrangement, other configurations are not excluded.

Also, in this embodiment, front display 56 has a width of 2 meters, and a height of 1.5 meters. At its maximum distance, background display 54 is 1 meter behind front display 56 at the centre of background display 54, but curves so as to be only 10 cm behind the extended plane of front display 54 at the edges of background display 54. Again, this distances can vary depending on the specific application.

Also, it should be noted that the images projected onto the background device 54 can be modified so as to account for the curved image on the flexible and/or curved background display 54. This type of modification or image adjustment is within the capability of the skilled artisan.

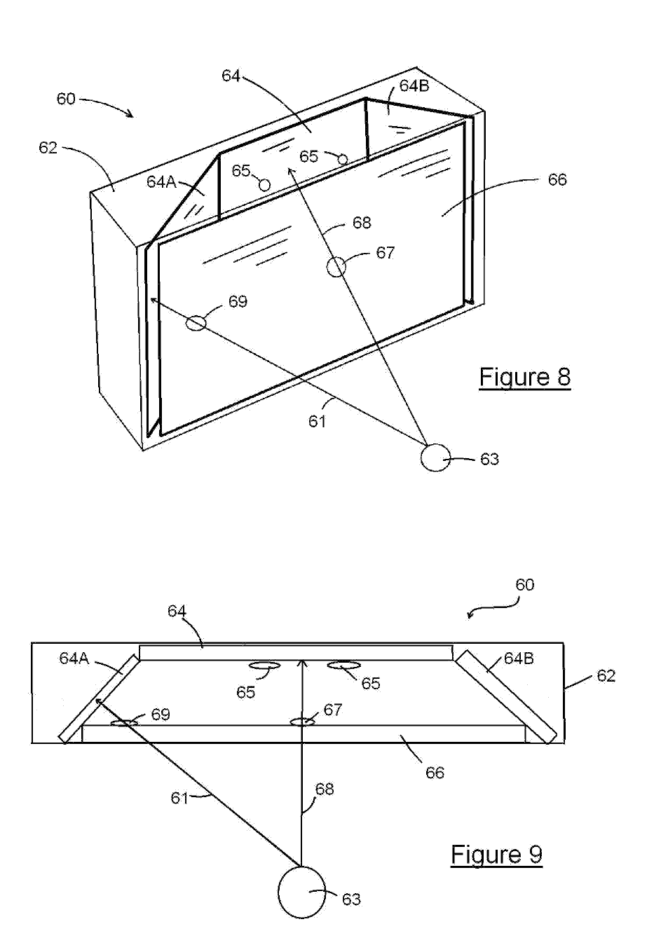

In FIGS. 8 and 9, a third embodiment of the display system apparatus 60 of the present invention is illustrated. In this approach, apparatus 60 comprises a case 62, in which a background screen 64, is shown near the back of case 60. Connected to the edges of background screen 64 are two additional display panels 64A and 64B which are angled from background screen 64 towards a front transparent display 66 at the front of case 60. It will be noted that additional display panels 64A and 64B extend to the extended plane of the front of the front transparent display 66, and thus, it is not possible to view any possible separation effect, as previously described.

When viewed in the direction shown by arrow 68, the viewer 63 will see the image 67 shown on front display 66, against the backdrop of the image 65 shown on background display 64, when the viewer 63 views the images from directly in front of case 62.

When viewing image 69 near the edge of front display 66, as shown by arrow 61, the viewer 63 still sees the image 69 against the backdrop of background display 64A. As such, the viewer does not lose the effect of having the background display behind image 69.

Again, the images shown on background display 64 can be modified to account for the parallel alignment of panel 64, and the angled alignment of panels 64A and 64B.

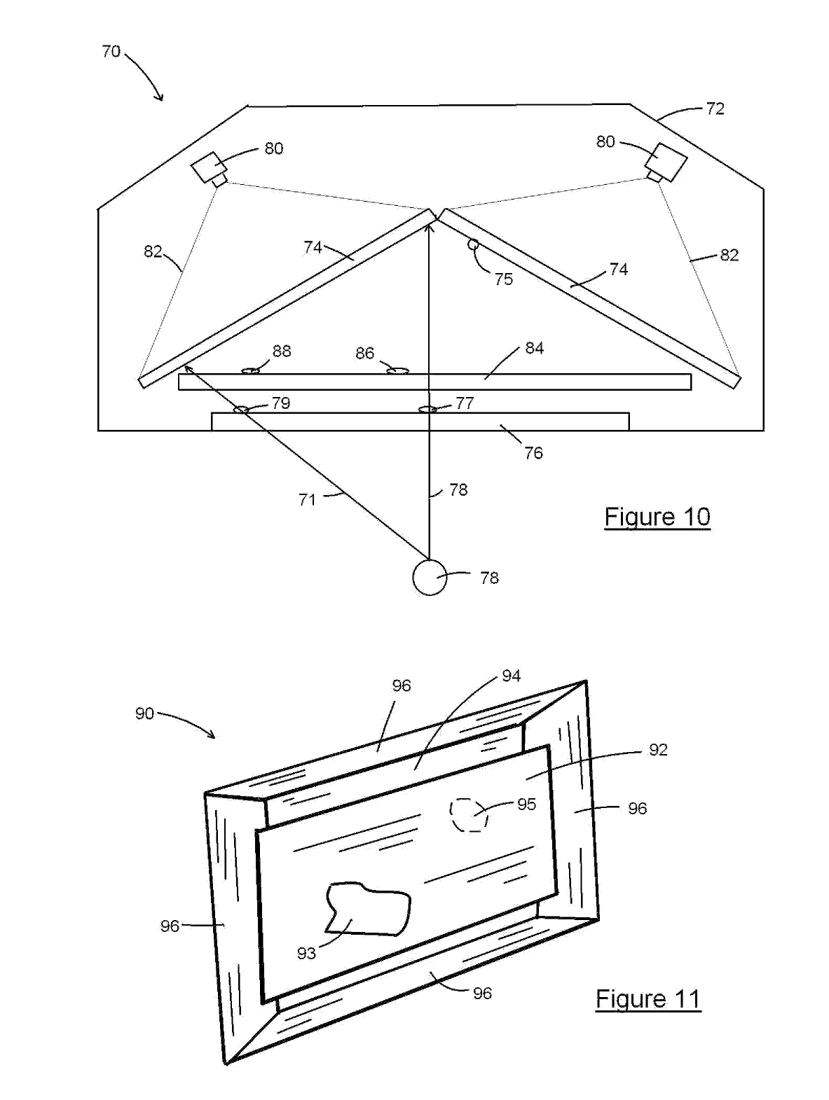

In FIG. 10, a further embodiment of the display system apparatus 70 is shown. In this approach, apparatus 70 comprises a case 72, in which two background display panels 74 are shown. The two panels 74 are angled one to the other. Panels 74 are rear projection panels, and the images shown on panels 74 are provided by projectors 80, which provide a light image depicted by reference numerals 82. At the front of case 72 is a front transparent LCD display 76. Between front display 76, and background display panels 74 is a further, intermediate transparent LCD display 84, which intermediate display 84 is wider than front display 76, but not as wide as the combined width of angled background panels 74.

When viewed in the direction shown by arrow 78, the viewer 73 will see the image 77 shown on front display 76, against the backdrop of the image 75 shown on background display 74, and image 86 shown on intermediate display 84, when the viewer 73 views the images from directly in front of case 72.

When viewing image 79 near the edge of front display 76, as shown by arrow 71, the viewer 73 still sees the image 79 against the backdrop of background display 74, and in relation to the image 88 shown on intermediate display 84. As such, the viewer does not lose the effect of having a background display behind image 79 and/or on intermediate display 84.

Further, intermediate display 84 can display image content that is interrelated to the images shown on front panel 76, background panels 74, and/or some combination of these panels.

In FIG. 11, a further apparatus 90 of the present invention is shown comprising a front display 92 in front of a planar background display 94. In this embodiment, no case is used. At the four sides of background display 94 are additional display units 96, which are connected to background display 94, and are angled towards front display 92. Using this approach, a viewer (not shown) would observe image 93 shown on front display 92, against a background image 95, shown on background display 94. At all four edges of the front panel 92, the viewer would be able to observe background images displayed on background display 94, or additional display units 96.

There has therefore been described a display apparatus which comprises a front display device having side edges, arranged to project a first image of a first program material towards a viewer, and a background display device having side edges, arranged to project a second image of a second program material towards a viewer, wherein said front display device and said background display device are separated to provide an apparent parallax effect between said first image and said second image, and wherein said background display device is sized so as to extend beyond the side edges of the front projection device.

Other modifications and alterations may be used in the design and manufacture of the apparatus of the present invention without departing from the spirit and scope of the accompanying claims.

Throughout this specification and the claims which follow, unless the context requires otherwise, the word “comprise”, and variations such as “comprises” or “comprising”, will be understood to imply the inclusion of a stated integer or step or group of integers or steps but not to the exclusion of any other integer or step or group of integers or steps.

Moreover, the word “substantially” when used with an adjective or adverb is intended to enhance the scope of the particular characteristic; e.g., substantially planar is intended to mean planar, nearly planar and/or exhibiting characteristics associated with a planar element. Further use of relative terms such as “vertical”, “horizontal”, “up”, “down”, and “side-to-side” are used in a relative sense to the normal orientation of the apparatus.

Moreover, use of the terms “he”, “him”, or “his”, is not intended to be specifically directed to persons of the masculine gender, and could easily be read as “she”, “her”, or “hers”, respectively.

1. A display apparatus comprising a front display device having side edges, arranged to project a first image of a first program material towards a viewer, and a background display device having side edges, arranged to project a second image of a second program material towards a viewer, wherein said front display device and said background display device are separated to provide an apparent parallax effect between said first image and said second image, and wherein said background display device extends beyond the side edges of the front projection device.

2. A display apparatus as claimed in claim 1 wherein said background display device is curved or angled so as to extend towards the plane of the front projection device.

3. A display apparatus as claimed in claim 2 wherein said side edges of the background display device extend essentially to an extended plane of the front display device.

4. A display apparatus as claimed in claim 1 wherein said front display device is a transparent display device.

5. A display apparatus as claimed in claim 4 wherein said front display device is a flat panel, transparent LCD display device.

6. A display apparatus as claimed in claim 1 wherein said background display device is a television screen or monitor.

7. A display apparatus as claimed in claim 6 wherein said background display device is a rear projection device.

8. A display apparatus as claimed in claim 6 wherein said background display device is a flat panel display device.

9. A display apparatus as claimed in claim 8 wherein said flat panel display device is a LCD, plasma, LED, OLED flat panel display, television or monitor.

10. A display apparatus as claimed in claim 1 wherein said background display device is a plurality of display devices arranged in 1×2 grids, 2×2 grids, 1×3 grids, 3×3 grids, 4×4 grids, 2×3 grids, or 3×2 grids.

11. A display apparatus as claimed in claim 1 wherein said background panel is parallel to, and co-planar with the front display panel, and extends at least 5% beyond the sides of the front panel display.

12. A display apparatus as claimed in claim 11 wherein said background display panel extends at least 20% beyond the side edges of the front panel display device.

13. A display apparatus as claimed in claim 2 wherein at least the edges of the background display device are curved or angled towards the extended plane of the front display panel.

14. A display apparatus as claimed in claim 13 wherein said background display comprises a flat panel display device which is parallel to the front panel, and additional background display panels at its edges which are angled towards the extended plane of the front display device.

15. A display apparatus as claimed in claim 13 wherein said background display is provided as a flexible display device which is placed so as to provide a continuously curving display panel behind said front display device.

16. A display apparatus as claimed in claim 15 wherein the edges of the background display device extends towards the extended plane of the front display by a distance which is at least 25% of a maximum distance between the front and background display devices.

17. A display apparatus as claimed in claim 15 wherein the edges of the background display device extends towards the extended plane of the front display by a distance which is at least 75% of a maximum distance between the front and background display devices.

18. A display apparatus as claimed in claim 1 wherein said background display device is vertically aligned, in at least one direction, with respect to the front display device.

19. A display apparatus as claimed in claim 1 comprising between 1 and 3 additional transparent display devices positioned between said front and said background display devices.

20. A display apparatus as claimed in claim 1 wherein the said first image of said first program material and said second image of said second program material are synchronized or interrelated.
